(19) United States
(12) Patent Application Publication
(10) Pub. No.: US 2003/0200134 A1
(43) Pub. Date: Oct. 23, 2003

(54) System and method for large-scale automatic forecasting

(76) Inventors: Michael James Leonard, Cary, NC (US); David Bruce Elsheimer, Garner, NC (US)

Correspondence Address: John V. Biernacki, Jones Day, North Point, 901 Lakeside Avenue, Cleveland, OH, 44114, US

(21) Appl. No.: 10/402,849

(22) Filed: Mar. 28, 2003

Related U.S. Application Data
(60) Provisional application No. 60/368,890, filed on Mar. 29, 2002.

(51) Int. Cl. G06F 17/60

(52) U.S. Cl. 705/10

(57) ABSTRACT

A computer-implemented method and system for large-scale automatic forecasting. The method and system determine which forecasting models in a pool of forecasting models may best predict input transactional data. Candidate models are selected from the pool of forecasting models by comparing characteristics of the models in the pool with characteristics of the input transaction data. To further reduce the number of models, hold-out sample analysis is performed for the candidate models. The candidate model(s) that best perform with respect to the hold-out sample analysis are used to generate forecasted output.

### CROSS REFERENCE TO RELATED CASE

This application claims the benefit of and priority to U.S. Provisional Patent Application Serial No. 60/368,890, filed Mar. 29, 2002, the entire disclosure of which (including the drawings) is incorporated herein by reference.

### TECHNICAL FIELD

The present invention relates generally to the field of forecasting. More particularly, the present invention relates to a system and method for large-scale automatic forecasting.

### BACKGROUND

Businesses often make predictions or forecasts based on large amounts of data collected from transactional databases, such as Internet websites or point-of-sale (POS) devices. Such data may be analyzed using time series techniques to model and forecast the data. However, the amount of data and number of time series needed to generate useful forecasts can grow so large as to make it impractical to perform effective time series analysis for large-scale forecasting.

### SUMMARY

A computer-implemented system and method are provided that overcome the aforementioned difficulties as well as others by allowing a large number of forecasts to be generated with little or no human intervention. The system and method determine which forecasting models in a pool of forecasting models may best predict input transactional data. Candidate models are selected from the pool of forecasting models by comparing characteristics of the models in the pool with characteristics of the input transactional data. To further reduce the number of models, hold-out sample analysis is performed for the candidate models. The candidate model(s) that best perform with respect to the hold-out sample analysis are used to generate forecasted output.

### BRIEF DESCRIPTION OF THE DRAWINGS

FIG. 1 is a block diagram of an exemplary automatic forecasting system;

FIGS. 2 and 3 are block diagrams depicting details of the forecasting model selection module shown in FIG. 1;

FIGS. 4-6 are graphs illustrating a hold-out sample analysis of three forecasting models;

FIG. 7 is a block diagram depicting software and computer components used to analyze forecasted output;

FIG. 8 is a graph illustrating an exemplary forecasted output;

FIGS. 9 and 10 are flowcharts illustrating an exemplary method of generating a forecasted output from a record of transactional data and a pool of forecasting models;

FIG. 11 is a block diagram of an exemplary automatic forecasting system for forecasting shelf item orders in a grocery store chain;

FIG. 12 is a block diagram of an exemplary automatic forecasting system for forecasting inventory items at manufacturing facilities;

FIG. 13 is a block diagram of an exemplary automatic forecasting system for use with special event analysis; and

FIG. 14 is a block diagram of an exemplary automatic forecasting system for use with intervention analysis.

### DETAILED DESCRIPTION

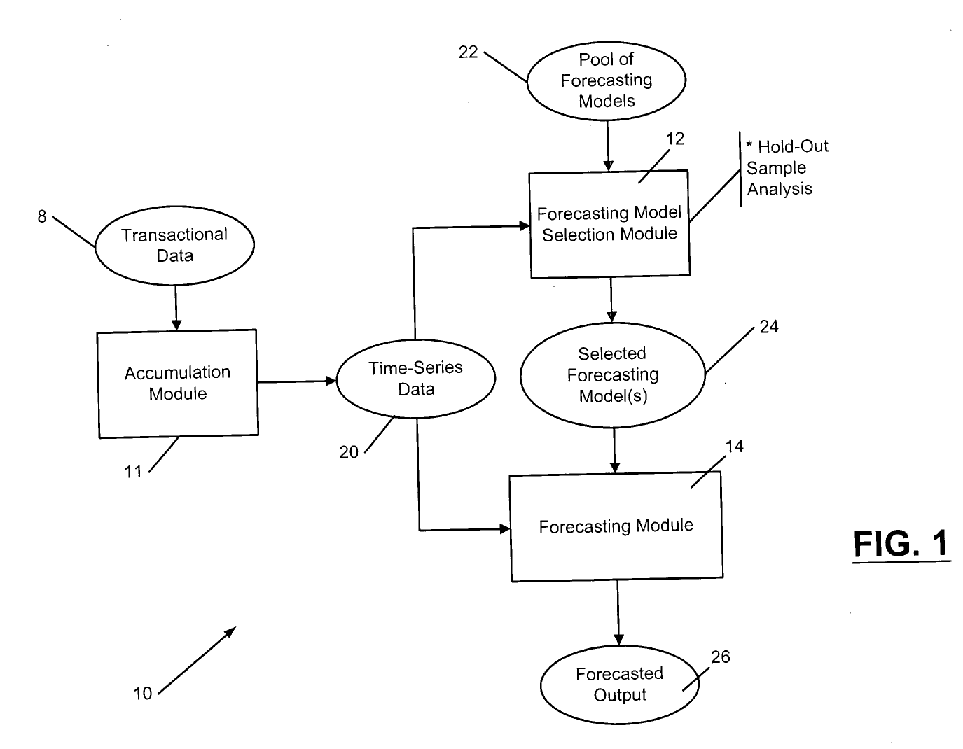

FIG. 1 depicts an exemplary automatic forecasting system 10 for determining which forecasting models in a pool 22 of forecasting models may best predict input transactional data 8. First, the system 10 is provided with a file of transactional data 8 which is typically time-stamped data collected over time at no particular frequency. For instance, transactional data 8 may include purchase data detailing when and how a customer purchased an item over the Internet. Other exemplary types of transactional data 8 include non-Internet point-of-sale (POS) data, inventory data, or trading data.

In order to analyze the transactional data 8 for trends and seasonal variations within the system 10, the transactional data 8 is converted into time series data 20. To accomplish this, module 11 accumulates the transactional data 8 by applying a statistical function to the transactional data 8 within a pre-selected time period. Examples of time periods include hourly, daily, weekly, monthly, or yearly periods. For instance, if a daily time series is desired, module 11 may accumulate a file of daily time series data by calculating the sum, mean, median, minimum, maximum, standard deviation, or some other statistic of the transactional data 8 during each twenty-four hour period.

After the time series data 20 is generated, a forecasting model selection module 12 examines which forecasting models in the pool 22 may be best suited to predict the time series data 20. The pool 22 may include a plurality of robust forecasting models (e.g., forecasting models that will forecast a large majority of typical time series well). Such forecasting models decompose a time series into its various components, such as the local level, trend, and seasonal components of a time series. For example, a local trend component describes the trend (up or down) at each point in time and a final trend component describes the expected future trend of a time series. In addition, each of the forecasting models in the pool 22 may include one or more parameters that may be adjusted to optimize the models in the pool 22 based upon the time series data 20.

The model selection module 12 compares at least one statistical characteristic of the time series data 20 with at least one pre-identified model characteristic of the forecasting models in the pool 22. From this comparison, the model selection module 12 forms a candidate list of those models that are statistically best suited to the time series data 20.

After the candidate forecasting models have been determined, the model selection module 12 performs a hold-out sample analysis to further reduce the number of models. The hold-out sample analysis involves partitioning the time series data 20 into two subsets. For example, the time series data may be partitioned into a first subset that contains all but the last period of the time series data 20 and a second subset that contains the last period of data. The model selection module 12 optimizes the candidate models with respect to the first subset of the time series data 20. Each optimized candidate model generates forecasts for the same time period as the time period contained in the second data subset. The model that provides the best forecast with respect to the second data subset is chosen as the selected forecasting model 24.

If a hold-out sample analysis was used by the model selection module 12 to select the forecasting model 24, then a forecasting module 14 may reoptimize the selected forecasting model 24 by fitting the model 24 to the full range of time series data 20. The optimized forecasting model is used by the forecasting module 14 to generate forecasted output 26 that predicts beyond the time period contained in the time series data 20. The forecasted output 26 may be used in a number of ways, such as using the predictions to gauge demand for a product over the next one or more periods.

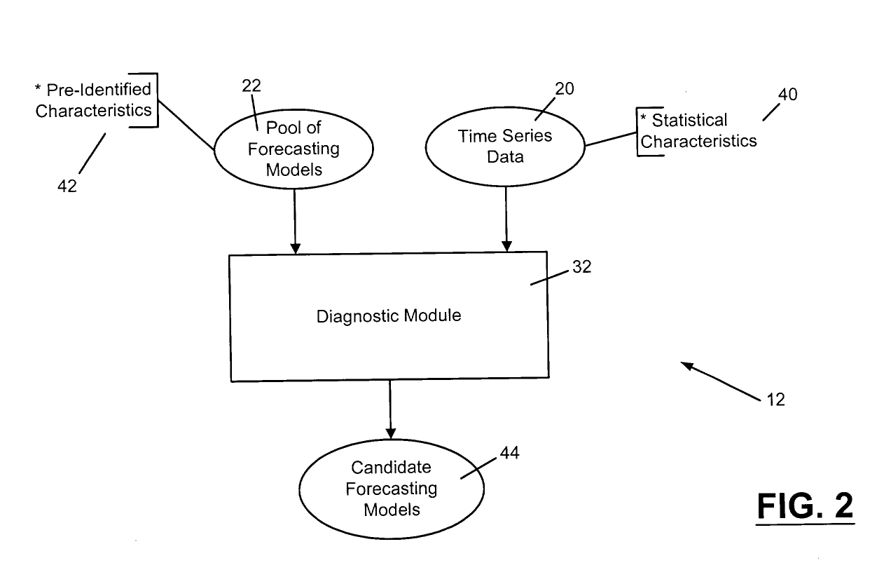

FIG. 2 illustrates a more detailed depiction of the model selection module 12 shown in FIG. 1. The model selection module 12 includes a diagnostic module 32 that compares the pool 22 of forecasting models with the input time series data 20. The diagnostic module 32 determines one or more statistical characteristics 40 of the time series data 20. The diagnostic module 32 then compares the statistical characteristics 40 with one or more pre-identified model characteristics 42 of the models in the pool 22 so that the pool 22 may be reduced to a smaller set of models 44. For example, if a time series exhibits trends (deterministic or stochastic), then the diagnostic module 32 selects those models that have a trend component. If a time series exhibits seasonal trends (deterministic or stochastic), then the diagnostic module 32 selects those models that have a seasonal component. If a time series exhibits an intermittent or interrupted characteristic, then the diagnostic module 32 selects intermittent models. In addition, if a time series is non-linear, then the diagnostic module 32 selects a transformed model. It is noted that the transformation may be autoselected based upon the type of series, and that a user may use his analytical experience to affect what portion of the series should be used as the hold-out for the series. It should be understood that certain models may best predict only one type of time series data while others may be able to predict two or more types of time series data.

Listed below are descriptions of exemplary forecasting models in the pool 22 that may be compared to the time series data 20. It should be understood, however, that these exemplary forecasting models are listed and described for illustrative purposes only, and are not intended to limit the types of forecasting models that may be included in the pool 22:

1. Local Level Models—Local level forecasting models may be used to forecast time series having a level (or mean) component that varies with time. These types of forecasting models can predict the local level for future periods. An example of a local level model is the Simple Exponential Smoothing model. The Simple Exponential Smoothing model includes one parameter (level weight) which determines how the local level evolves, and the forecast for a future period is the local level (a constant) corresponding to the period.

2. Local Trend Models—Local trend models may be used to forecast time series that include level and/or trend components that vary with time. These types of forecasting models can predict the local level and trend for future periods. Some examples of local trend models include the Double (Brown) model, the Linear (Holt) model, and Damped-Trend Exponential Smoothing model. The Double model includes one parameter (level/trend weight), the Linear model includes two parameters (level and trend weights), and the Damped-Trend Exponential Smoothing model includes three parameters (level, trend, and damping weights). In each of these three models, the forecast for a future period is a combination of the local level and the local trend for the period. In the Damped-Trend Exponential Smoothing model, the damping weight parameter dampens the trend over time.

3. Local Seasonal Models—Local seasonal models may be used to forecast time series that include level and/or seasonal components that vary with time. These types of forecasting models can predict the local level and season for future periods. An example of a local seasonal model is the Seasonal Exponential Smoothing model. The Seasonal Exponential Smoothing model includes two parameters (level and seasonal weights), and the forecast for a future period is a combination of the local level and the local season for the period.

4. General Local Models—General local models may be used to forecast time series that include level, trend, and/or seasonal components that vary with time. These types of forecasting models can predict the local level, trend, and season for future periods. An example of a general local model is the Winters Method (additive or multiplicative). The Winters Method includes three parameters (level, trend, and seasonal weights), and the forecast for a future period is a combination of the local level, local trend, and local season corresponding to the period.

5. Intermittent Models—Intermittent or interrupted time series models may be used to forecast intermittent time series data. An example of an intermittent model is the Croston's Method. Intermittent time series are predominantly constant valued (usually zero) except on relatively few occasions. It is therefore easier to predict when an intermittent time series will depart, and how much the time series will depart, from this predominantly constant value, rather than to predict the next value of the series. The Croston's Method thus decomposes the time series data into two parts: an interval series and a size series. The interval series measures the number of periods between departures from the predominantly constant value, and the size series measures the magnitude of such departures. After decomposition, each of the two parts are modeled and forecast independently. The interval series forecasts when the next departure will occur, and the size series forecasts the magnitude of the departure. The interval and size series forecasts are then combined to produce a forecast for the average departure from the predominantly constant value for the next time period.

6. Transformed Models—If a non-linear forecasting model is used for automatic forecasting, a transformed version of the series is created, the automatic forecasting is performed on the transformed series, and then the fitted model is inversely transformed. For example, a non-linear forecasting model may be transformed into a linear forecasting model using a logarithmic, square-root, logistic, or Box-Cox time series transformation.

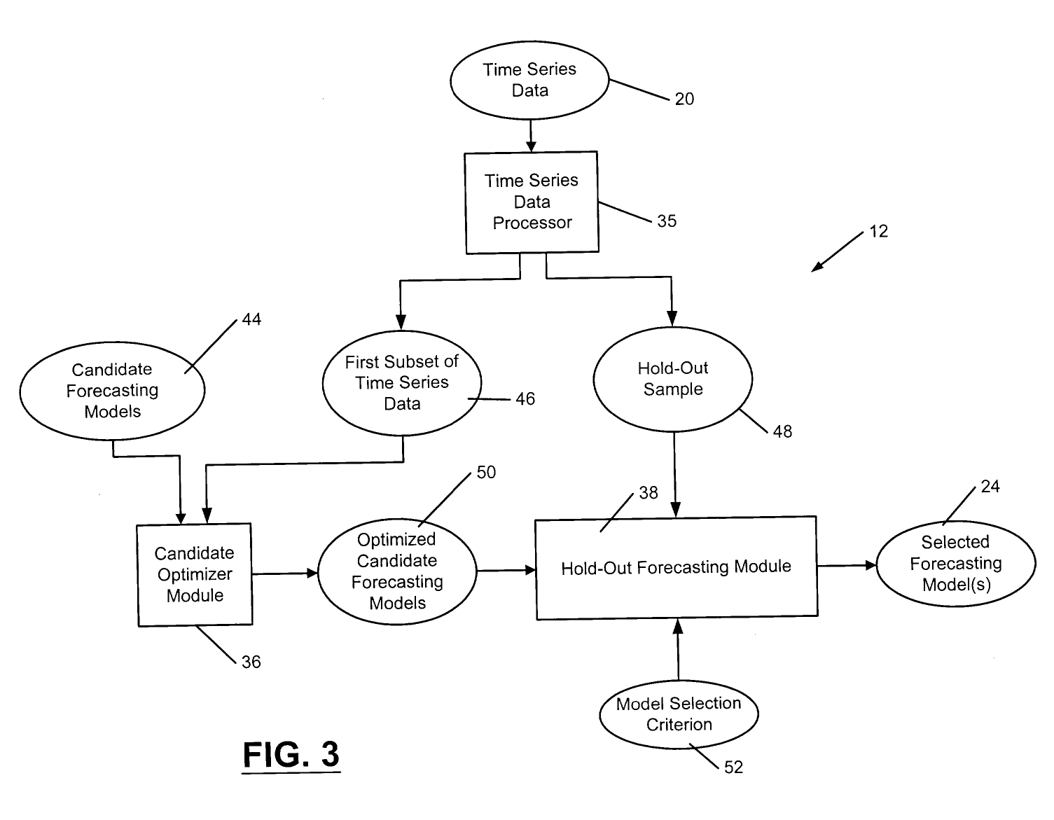

The models selected by the diagnostic modules are further reduced in number by the system through a hold-out sample analysis. FIG. 3 depicts modules used in performing a hold-out sample analysis. The analysis helps determine which of the candidate models 44 (selected by the diagnostic module) statistically performs best with respect to the time series data 20. A time series data processor 35 partitions the time series data 20 into two subsets 46 and 48. The time series data 20 may be partitioned into a first subset 46 that contains all but the last period of data and a second subset 48 that contains the last period of data (note that the second subset may also be termed the hold-out sample). However it should be understood that the data may be partitioned in many different ways, such as performing the partition so that the hold-out data portion includes two or more of the concluding periods in the time series data (or even includes just a portion of a period, such as one-half or one and a half periods). It should also be understood that alternate embodiments of the model selection module 12 may select a forecasting model 24 using a method other than a hold-out analysis, for instance the full range of time series data 20 may alternatively be used to both fit and evaluate the candidate forecasting models.

A candidate optimizer module 36 optimizes (or fits) each candidate model 44 to the first data subset 46. The candidate models 44 are optimized with respect to the first data subset 46 by adjusting the parameters of each candidate model 44 to minimize residuals between the first data subset 46 and values generated by the candidate models 44. Based upon the optimization, the candidate optimizer module 36 generates optimized candidate models 50.

A hold-out forecasting module 38 generates a forecast with each of the models 50. The forecasting module 38 then compares the forecast of each model 50 with the actual data in the hold-out sample 48 in order to determine which of the models 50 has most closely predicted the hold-out sample 48. This comparison is made by calculating one or more statistics-of-fit to serve as model selection criteria 52 for each forecast. For example, the mean square error (MSE), mean absolute percentage error (MAPE), Akaike information criteria (AIC), or another statistic-of-fit may by chosen as the model selection criterion 52. The statistics-of-fit are calculated from the prediction errors between the forecasted data and the hold-out sample 48. For instance, if the MAPE is chosen as the model selection criterion 52, then the forecasting model 50 with the smallest MAPE in the evaluation region (e.g., the hold-out sample region) is chosen by the forecasting module 38 as the selected forecasting model 24. It should be understood that the selection may involve using more than one selection criteria, such by assigning weighted ranks to each criteria and determining which model forecasted the best with respect to the weighted ranks. Also different statistics-of-fit may be used depending upon which models are initially selected from the pool. For example, one type of statistic-of-fit may be used when dealing with a local seasonal model and another type of statistic-of-fit may be used when dealing with a Winters method multiplicative model. It should be further understood that in an alternate embodiment more than one selected model 24 may be selected by the forecasting module 38 in the event that one of the selected models 24 later fails to perform adequately.

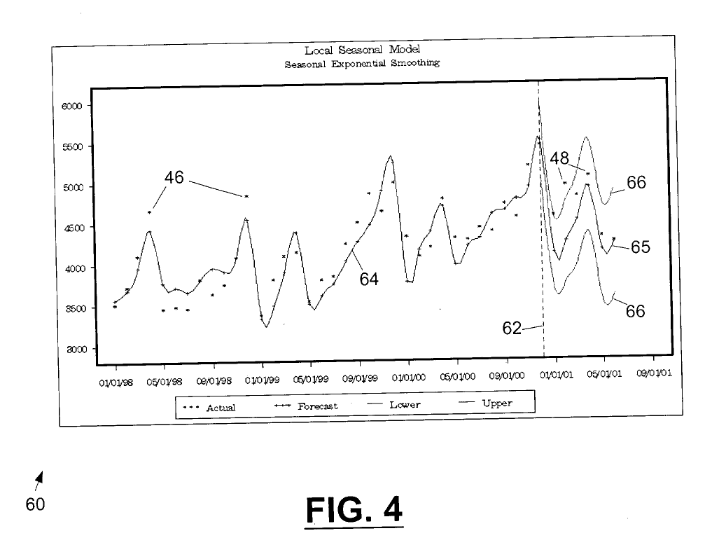

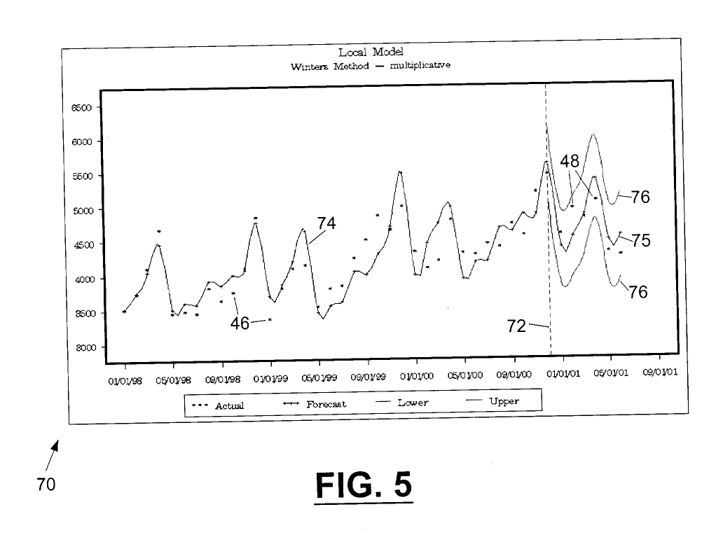

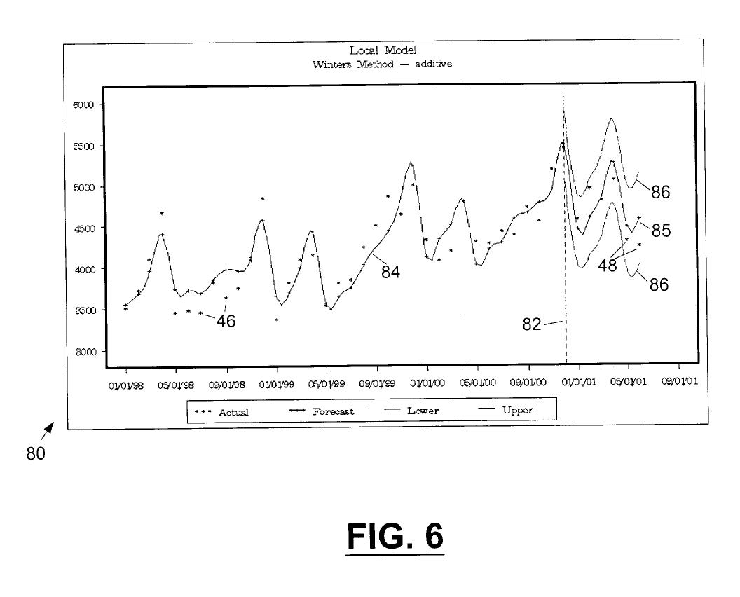

FIGS. 4-6 are graphs illustrating a hold-out sample analysis of three forecasting models 60, 70, 80 in three different situations. FIG. 4 illustrates a local seasonal model 60; FIG. 5 is a Winters method-multiplicative model 70; and FIG. 6 shows a Winters method-additive model 80. The first subset of time series data 46 is illustrated in each graph as a plurality of asterisks to the left of vertical dotted lines 62, 72, 82, and the hold-out sample 48 is illustrated in each graph as a plurality of asterisks to the right of the dotted line 62, 72, 82. The forecasting models are plotted as solid lines 64, 74, 84 to the left of the vertical dotted lines 62, 72, 82 on each graph. In addition, each graph 60, 70, 80 includes a prediction 65, 75, 85 made by a selected model, and upper and lower confidence limits 66, 76, 86 plotted as solid lines to the right of the vertical dotted lines 62, 72, 82.

In these graphs, each model is optimized (or fitted) by adjusting the model parameters to minimize the residuals, i.e., the distances between the model and the actual data in the first subset of the time series data 46. The predictions 65, 75, 85 and confidence limits 66, 76, 86 are generated using the optimized models, and are the forecast of each model. The forecasts may then be statistically compared with the hold-out sample 48 in order to generate statistics-of-fit to select the model that is most closely related to the hold-out sample 48.

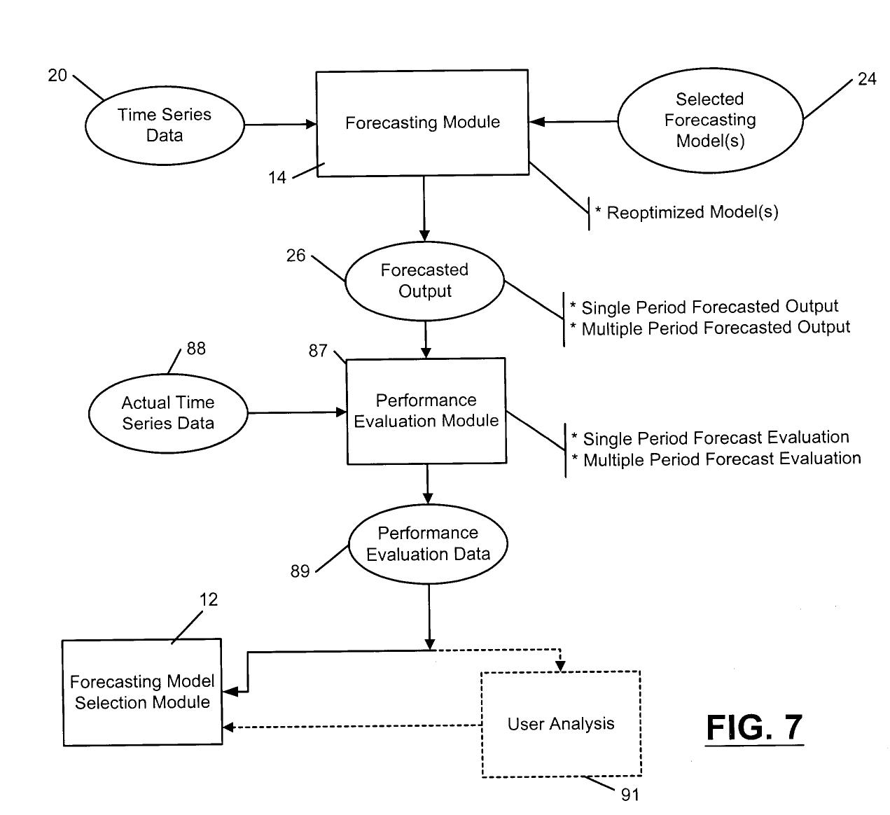

The selected forecasting model from the selection module 12 may be used in many ways. FIG. 7 illustrates a use of the selected forecasting model 24 in forecasting beyond the time periods contained in the originally provided time series data 20. The forecasting module 14 can generate forecasted output 26 that is for one period or more in the future. Preferably, a user of the system can pre-select the number of future periods to be forecasted by the forecasting module 14. The number of future periods to be forecasted is referred to by those skilled in the art as the forecast horizon or forecast lead. The forecast for the next future period is referred to herein as the one-step ahead forecast. The forecast for the last period in the forecast is referred to herein as the h-step ahead forecast (i.e., one-step ahead forecast, two-step ahead forecast, . . . , h-step ahead forecast).

In addition to predictive period data, the forecasted output 26 may include prediction standard errors, confidence limits and other similar forecast statistics based upon the time series data 20. These data may be expressed as a set of random variables that have an associated probability distribution. For example, assuming a normal distribution, a multiple period forecast for the next three time-periods may be viewed as three bell-curves that are progressively flatter or wider. The prediction is the mean or median of each forecast. The prediction standard error is the square root of the prediction error variance of each forecast which is calculated from the forecast model parameter estimates and the model residual variance. The confidence limits are based on the prediction standard errors and a pre-selected confidence limit size. Confidence limits may be calculated assuming a normal distribution.

The forecasting module 14 may re-optimize the selected forecasting model(s) 24 before generating the forecasted output 26. For instance, the forecasting module 14 may optimize the selected forecasting model(s) with respect to all of the time series data 20. It is noted that if the selected forecasting model 24 is a transformed forecasting model, then the forecasting module 14 also performs transformations on both the time series data 20 and the forecasted output 26. The non-linear time series data 20 is transformed into linear data which is used to optimize (fit) the selected forecasting model 24. The forecasted output 26 is then calculated using the parameter estimates and the transformed time series data, and the forecasted output 26 (predictions, predictions standard errors, confidence limits, etc.) is generated by performing an inverse transform on the data. The naive inverse transformation results in median forecasts. To obtain mean forecasts, the prediction and prediction error variance are both adjusted based on the transformation.

After the forecasted output 26 is generated, a performance evaluation module 87 compares the forecasted period output 26 with actual time series data 22 from the corresponding time period in order to generate one or more out-of-sample statistics of fit. The statistics of fit are analyzed by the evaluation module 87 to identify poorly fitting forecasting models 24. For instance, if the statistics-of-fit indicate that a selected forecasting model 24 did not accurately forecast the actual time series data 88, then the forecasting model 24 may be flagged by the evaluation module 87 to signal the need for user analysis 91. A selected forecasting model 24 may, for example, be flagged by the evaluation module 87 if its statistics-of-fit do not fall within a pre-selected range. Upon evaluating the output 89 from the evaluation module 87, user analysis 91 may indicate to the model selection module 12 to replace a poorly performing model. For instance, if the selected forecasting model 24 does not accurately forecast the actual time series data 88, then a more detailed analysis of the actual time series data 88 may be initiated by the user to identify a more appropriate forecasting model. The user may then either select a different forecasting model from the candidate pool of forecasting models or possibly load a new forecasting model into the system. In addition, the performance evaluation data 89 may directly be provided to the model selection module 12. In both cases, module 12 may use the information from the evaluation module 87 and/or user analysis 91 to hone its selection and optimization process the next time that a model is to be selected in a similar situation.

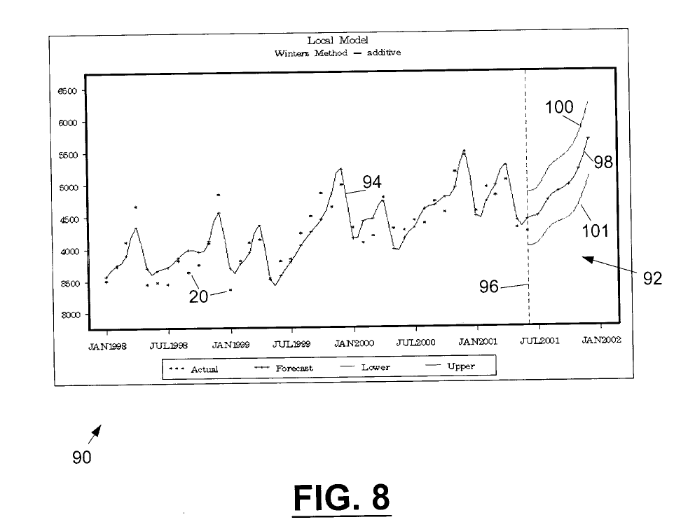

FIG. 8 depicts a graph 90 of an exemplary forecasted output 92. The graph 90 includes actual time series data 20 and predictions 94 from a forecasting model plotted to the left of a vertical dotted line 96. The time series data 20 is illustrated by asterisks on the graph 90, and predictions 94 from the forecasting model are illustrated by a solid line. In addition, the graph 90 includes predictions 98 beyond the period of the actual data, an upper confidence limit 100 and a lower confidence limit 101 plotted as solid lines to the right of the vertical dotted line 96. The confidence limits in this example are shown at a confidence level of 0.05 (i.e., 95% confidence limits), but may be at any level that best fits the situation at hand.

The illustrated forecasted output 92 has a forecast horizon extending from a time-period slightly before July 2001 until a time-period slightly before January 2002. The predictions 98 indicate that, according to the selected forecasting model (Winters method), the demand will likely increase from about 4400 to about 5750 during the forecast horizon.

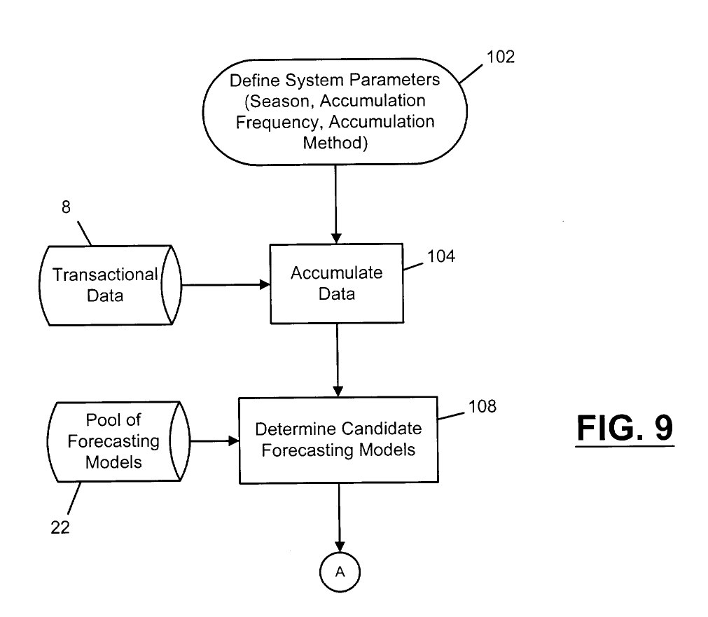

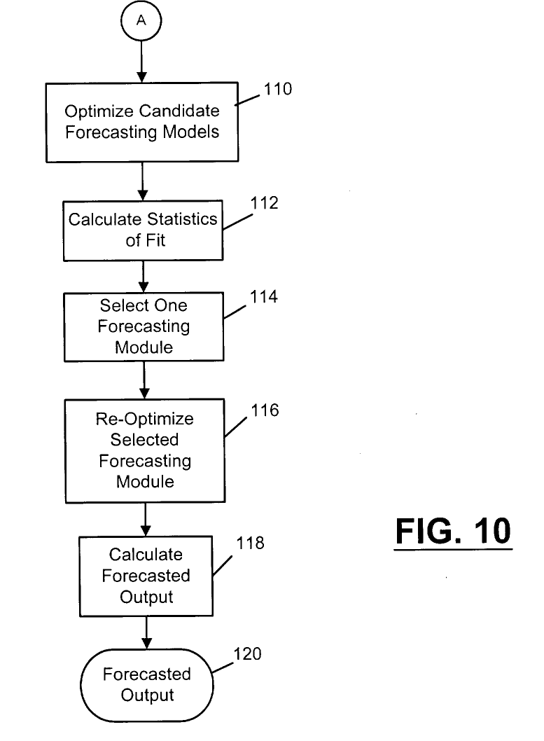

FIGS. 9 and 10 are flowcharts illustrating an exemplary method for generating a forecasted output from a file of transactional data 8 and a pool 22 of forecasting models. In step 102 of FIG. 9, at least one parameter is defined, by a user of a system implementing the exemplary method or are predefined in the system. These parameters may include, for example, an accumulation frequency, a seasonal cycle, and an accumulation method. The accumulation frequency indicates the time interval or period (daily, monthly, yearly, etc.) at which the transactional data 8 is to be accumulated into time series data. The seasonal cycle or seasonality indicates the number of periods in one season. For instance, the seasonality selected for a monthly time series may be twelve periods to reflect a one year season. The accumulation method indicates the statistical method used to convert the transactional data 8 into time series data, for example the sum, mean, median, minimum, maximum, standard deviation or some other statistic may be selected.

Once the parameters have been selected, time series data is accumulated in step 104 from the transactional data 8 using the selected parameters. The time series data is then used in step 108 to select candidate forecasting models from the pool of forecasting models 22. This step may be performed by determining at least one statistical characteristic of the time series data, and comparing the statistical characteristic to one or more pre-identified statistical characteristics of the forecasting models in the pool 22.

In steps 110, 112, and 114 of FIG. 10, a hold-out sample analysis is performed on the candidate forecasting models selected in step 108 in order to rank forecasting models with respect to how well they statistically perform. In step 110, the candidate forecasting models are optimized by adjusting the parameter(s) of each model in order to fit the model to a subset of the time series data that has a hold-out sample excluded. Then, in step 112 a forecasted output for each candidate model is compared to the hold-out sample in order to generate a statistic-of-fit for each model. The statistics-of-fit are compared in step 114 in order to select forecasting model(s) that are statistically best-suited for predicting future time series data.

In step 116, the selected forecasting model is re-optimized by fitting the model to the entire range of time series data (including the hold-out sample). This step ensures that the most recent time series data is considered when the model is used to generate a forecasted output. The forecasted output is calculated in step 118, and may include a combination of a prediction, an upper and lower confidence limit, and possibly other statistics for a future period of the time series data. The method ends at step 120 with the generation of the forecasted output 120.

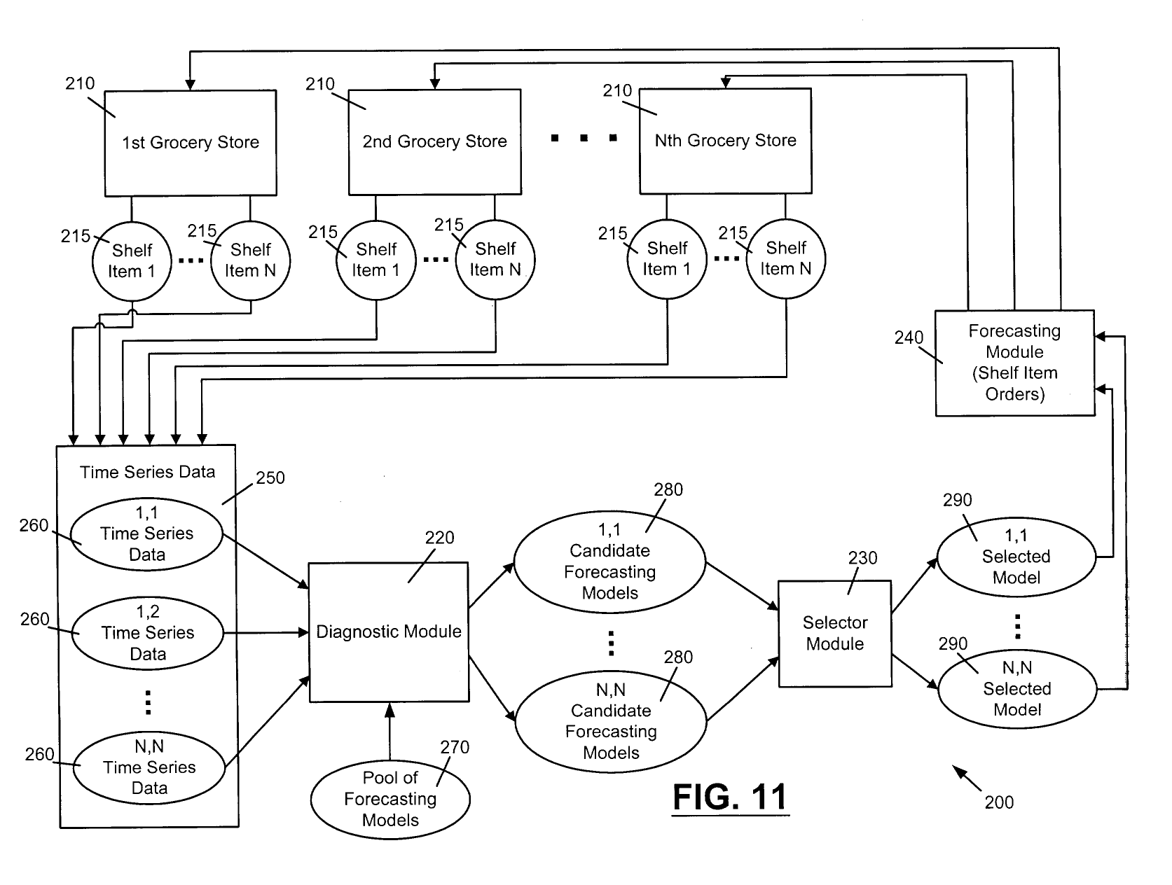

Such a method and system may be used in many applications. FIG. 11 exemplifies a use of the forecasting system 200 wherein shelf item orders are forecasted for a grocery store chain having many grocery stores 210. In this example, the system 200 includes a diagnostic module 220, a selector module 230, and a forecasting module 240. Operationally, the system 200 forms a file of time series data 250 relating to the sale of particular shelf items 215 from the grocery stores 210, and generates shelf item orders for a grocery store 210 by forecasting future shelf item sales at 240.

Each store 210 in the grocery store chain logs transactional data relating to the sale of shelf items 215 within the store 210. The transactional data logs/files are accumulated and stored within the file of time series data 250. The transactional data may be logged, for example, by a point-of-sale (POS) device within each store 210, and automatically accumulated into time series data 250 at some regular time interval. The file of time series data 250 includes a plurality of data subsets 260, preferably organized into a matrix. The matrix contains the time series data for the shelf items 215 and grocery stores 210. For instance, one data subset 260 may include a file of time series data representing the sale of one particular brand of canned peas at one of the grocery stores 210. It is noted that the system 200 has the capability to automatically evaluate and select prediction models for millions of time series for applications with individually optimized parameters for each time series (or vastly many of the time series). The capability allows for data intensive operations to be more greatly scrutinized, such as analyzing on a daily basis large amounts of web activity data or the vast quantity of product sales data generated by a retail store.

The diagnostic module 220 receives each subset 260 as an input, and compares at least one statistical characteristic of each data subset 260 with pre-identified characteristics of the forecasting models in the pool 270. Based on these comparisons, the diagnostic module 220 selects candidate forecasting models 280 for each data subset 260. The selector module 230 then performs a hold-out sample analysis for the candidate forecasting models 280 in order to select one forecasting model 290 that is statistically best-suited for the particular store 210 and series 260 for a particular shelf item 215. Using the selected forecasting models 290, the forecasting module 240 generates a forecasted output (or shelf item order) for each grocery store 210 that may include forecasts for each shelf item 215 within the store 210.

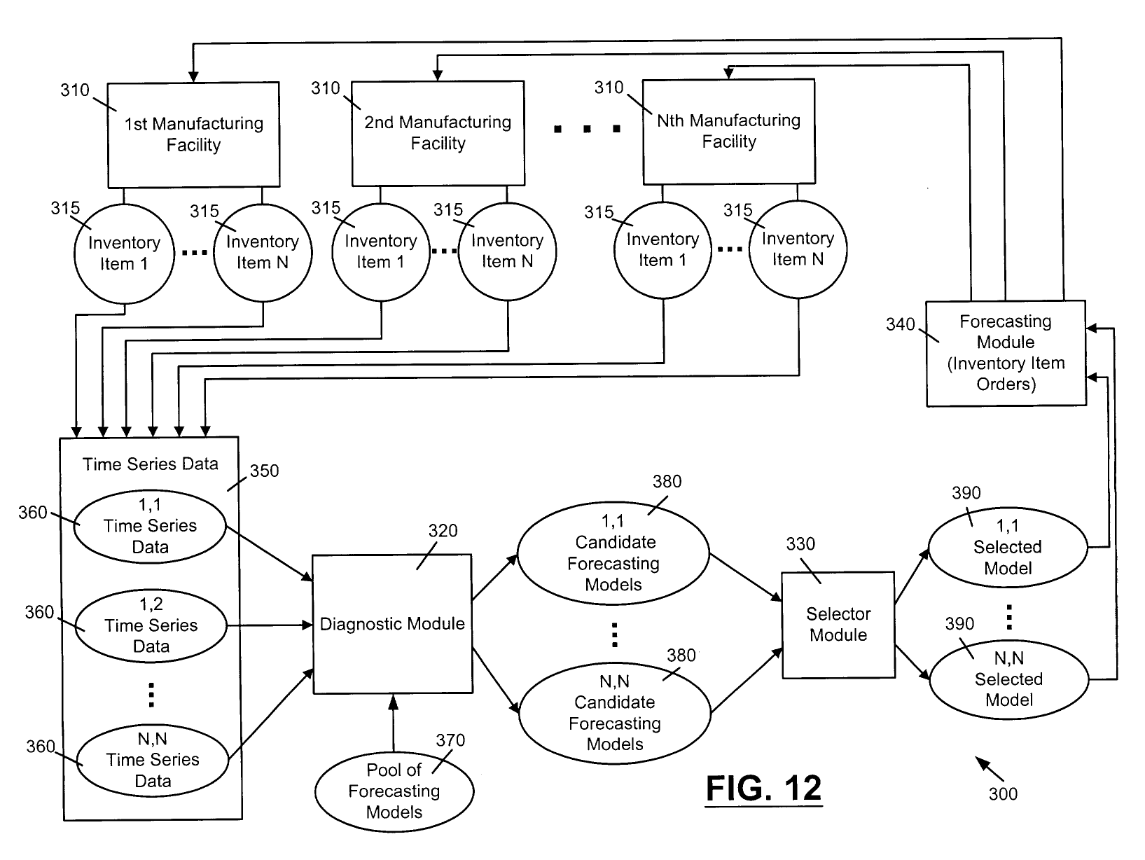

It is noted that this written description uses examples to disclose the invention and also to enable any person skilled in the art to make and use the invention. The patentable scope of the invention is defined by the claims, and may include other examples that occur to those skilled in the art. For example, the forecasting system and method may be used in a manufacturing situation, such as in the example illustrated in FIG. 12. FIG. 12 illustrates the forecasting system 300 wherein inventory items at manufacturing facilities 310 are forecasted. The forecasting system 300 forecasts the depletion of inventory items 315 at one or more manufacturing facilities 310. Transactional data relating to the quantity of each inventory item 315 may be recorded, for example, as each inventory item 315 is transferred out of inventory. The transactional data is then accumulated into a plurality of subsets 360 of time series data, and a forecasting model 390 is selected for each data subset 360. A forecasting module 340 is used to generate a forecasted output (or inventory item order) for each of the manufacturing facilities 310 that may include a forecast for each of the specific inventory items 315.

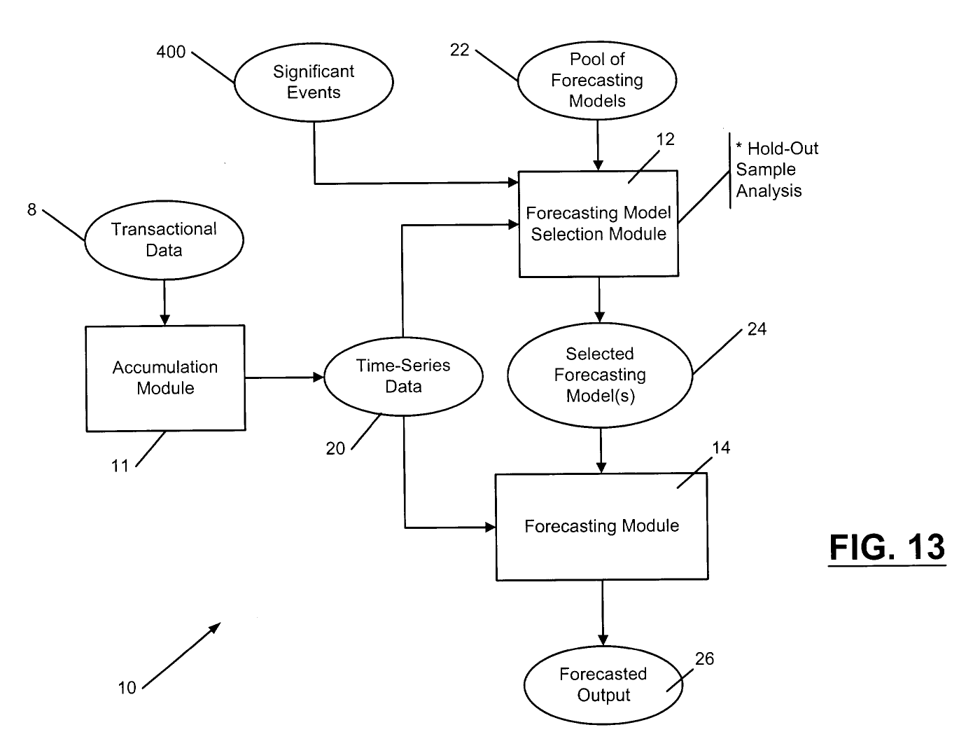

As a further example of the broad range of the forecasting system, FIG. 13 shows the automatic forecasting system 10 being used with special event analysis. Special events that occur during the calendar year may cause the time series to deviate from the underlying process. These events are assumed to occur at a specified time and endure for a specified number of periods. Sometimes these events are planned (sales promotions, shutdowns, etc.) and sometimes these events are unplanned (bad weather, strikes, etc.). In this example, significant events 400 are incorporated into the model and used by the forecasting model selection module 12 as part of the model selection process. Insignificant events may be ignored in forecasting to prevent over-parameterization. Events that conflict with the structure of the model may also be ignored. For example, seasonal events (e.g. Christmas and monthly time series) may be ignored when using seasonal models. As part of the model selection process, events 400 that are determined to be significant are incorporated into the candidate models.

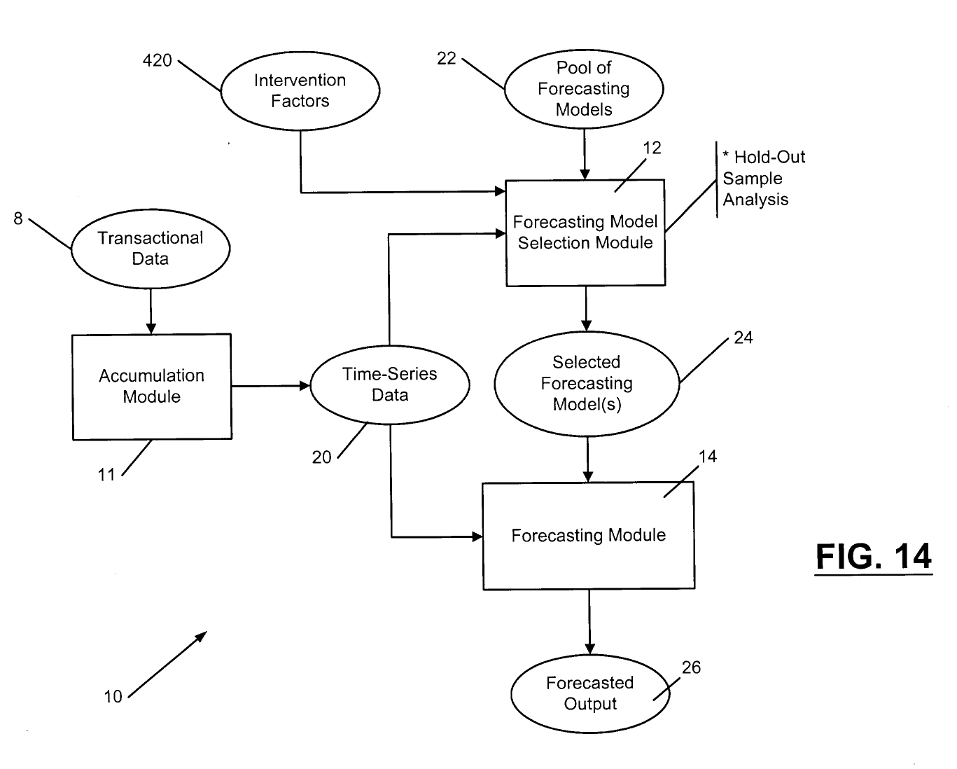

As yet another example of the broad range of the forecasting system, FIG. 14 shows the automatic forecasting system being used with intervention analysis. Intervention analysis (such as through use of intervention factors 420) may be used to model historical data to help explain deviations from an underlying time series process. Deviations may arise when invention events or factors 420 occur, such as when a promotion is introduced. A promotion may alter the buying habits of consumers. To better understand the impact of intervention factors 420 and hence the value of past and future promotions, many time series may need to be forecasted for which task the forecasting system is well adept to handle.

In a more detailed example involving sales promotions and intervention analysis, many companies use sales promotions to increase the demand for or visibility of a product or service. These promotions often require increased expenditures (such as advertising) or loss of revenue (such as discounts), and/or additional costs (such as increased product costs). Company managers need to determine the value of previous or proposed promotions. One way to evaluate promotions is to analyze the historical data using time series analysis techniques. Intervention analysis may be used to more accurately model the historical data taking into account one or more past promotions. This type of promotional analysis may help determine how past promotions affected the historical sales and help predict how proposed promotions may affect the future based on similar, past promotions. Intervention analysis is described in greater detail in Appendix A of U.S. Provisional Application Serial No. 60/368,890.

It is claimed:

1. A computer-implemented method for automatically selecting forecasting models, comprising the steps of:
receiving a pool of forecasting models, wherein the forecasting models in the pool have at least one pre-identified model characteristic;
receiving time series data indicative of transactional activity;
determining at least one statistical characteristic of the time series data;
comparing the determined statistical characteristic of the time series data with the pre-identified model characteristic of the forecasting models in the pool to identify candidate forecasting models;
determining a data subset from the time series data and a hold-out sample from the time series data;
optimizing at least one parameter of the candidate forecasting models using the time series data subset;
calculating statistics-of-fit for the candidate forecasting models using the hold-out sample; and
selecting at least one of the candidate forecasting models based upon the calculated statistics-of-fit of the candidate forecasting models.

2. The method of claim 1, wherein the time series data includes data representative of operating a physical system over a period of time.

3. The method of claim 2, wherein the physical system is a manufacturing system.

4. The method of claim 2, wherein the physical system is a system selected from the group consisting of a grocery store chain, a retail store chain, and combinations thereof.

5. The method of claim 1, further comprising the step of:
optimizing at least one parameter of the selected candidate forecasting model using substantially all of the time series data.

6. The method of claim 1, further comprising the step of:
generating a forecasted output using the selected candidate forecasting model.

7. The method of claim 6, wherein the forecasted output includes a prediction, an upper confidence limit, and a lower confidence limit.

8. The method of claim 1, wherein the time series data is accumulated from a file of transactional data using at least one pre-selected parameter.

9. The method of claim 8, wherein the pre-selected parameters include an accumulation frequency, a seasonal cycle, and an accumulation method.

10. The method of claim 8, wherein the file of transactional data is accumulated from an Internet website.

11. The method of claim 8, wherein the file of transactional data is accumulated from a point-of-sale (POS) device.

12. The method of claim 1, further comprising the step of:
generating a forecasted output for one time period using the selected candidate forecasting model;
receiving additional time series data for the one time period; and
calculating at least one in-sample statistic-of-fit for the selected candidate forecasting model using the forecasted output and the additional time series data.

13. The method of claim 12, further comprising the step of:
generating an evaluation output that indicates the in-sample statistic-of-fit.

14. The method of claim 13, further comprising the step of:
selecting a new candidate forecasting model from the pool of forecasting models based on the evaluation output.

15. The method of claim 1, further comprising the step of:
generating a forecasted output for a plurality of time periods using the selected candidate forecasting model;
receiving additional time series data for the plurality of time periods; and
calculating at least one in-sample statistic-of-fit for the selected candidate forecasting model using the forecasted output and the additional time series data.

16. The method of claim 15, further comprising the step of:
generating a performance analysis output that indicates the in-sample statistic-of-fit.

17. The method of claim 16, further comprising the step of:
selecting a new candidate forecasting model from the pool of forecasting models based on the performance analysis output.

18. The method of claim 1, further comprising the step of:
receiving special event information,
wherein the special event information is incorporated into a candidate forecasting model.

19. The method of claim 18, wherein the special event information includes at least one special event that occurs during a calendar year and causes deviations to occur within the time series data.

20. The method of claim 19, wherein the special event occur at a specified time and endures for a specified time period.

21. The method of claim 1, wherein the time series data includes historical data about one or more past promotions, wherein a candidate forecasting model is selected after taking into account intervention factors.

22. The method of claim 21, wherein the intervention analysis is used to assess one or more past promotions.

23. An automatic forecasting system, comprising:
a pool of forecasting models, wherein each forecasting model has at least one pre-identified model characteristic;
a file containing time series data indicative of transactional activity;
a forecasting model selection module that receives the file of time series data and selects at least one forecasting model from the pool of forecasting models by determining at least one statistical characteristic of the time series data and comparing the statistical characteristic with the pre-identified model characteristic of the forecasting models in the pool; and
a forecasting module coupled to the forecasting model selection module that fits the selected forecasting model to the time series data and generates a forecasted output.

24. The automatic forecasting system of claim 23, wherein the file of time series data comprises time series data that has been accumulated from a file of transactional data.

25. The automatic forecasting system of claim 23, wherein the forecasting model selection module comprises:
a diagnostic module that receives a file of time series data, and that determines the statistical characteristic of the time series data and compares the statistical characteristic with the pre-identified model characteristic of each forecasting model to determine candidate forecasting models; and
a selector module coupled to the diagnostic module that calculates a statistic-of fit for each candidate forecasting model, and compares the statistics-of-fit to select the forecasting model.

26. The automatic forecasting system of claim 25, wherein the statistic-of-fit calculated by the selector module is of a type selected by a system user as a model selection criterion.

27. The automatic forecasting system of claim 25, wherein the selector module further comprising:
a candidate optimizer module coupled to the diagnostic module that optimizes at least one parameter of the candidate forecasting models using a subset of the time series data; and
a hold-out forecasting module coupled to the candidate optimizer module that calculates a statistic-of-fit for each candidate forecasting model, and that selects the candidate forecasting model based on the statistics-of-fit.

28. The automatic forecasting system of claim 23, wherein the forecasted output includes one-step ahead forecast data, and further comprising:
an evaluation module that receives the one-step ahead forecast data from the forecasting module and receives a file of actual data corresponding to the one-step ahead forecast data, and that is configured to calculate a statistic-of-fit from the one-step ahead forecast data and the file of actual data.

29. The automatic forecasting system of claim 23, wherein the forecasted output includes h-step ahead forecast data, and further comprising:
a performance analysis module that receives the h-step ahead forecast data from the forecasting module and receives a file of actual data corresponding to the h-step ahead forecast data, and that is configured to calculate a statistic-of-fit from the h-step ahead forecast data and the file of actual data.

30. The automatic forecasting system of claim 23, wherein special event information is incorporated into the selected forecasting model.

31. The automatic forecasting system of claim 30, wherein the special event information includes at least one special event that occurs during a calendar year and causes deviations to occur within the time series data.

32. The automatic forecasting system of claim 31, wherein the special event occur at a specified time and endures for a specified time period.

33. The automatic forecasting system of claim 23, wherein the time series data includes historical data about one or more past promotions, wherein a forecasting model is selected after taking into account intervention factors.

34. The automatic forecasting system of claim 33, wherein the intervention analysis is used to assess one or more past promotions.

35. A computer-implemented apparatus for automatically selecting forecasting models, comprising:
means for receiving a pool of forecasting models, wherein the forecasting models in the pool have at least one pre-identified model characteristic;
means for receiving time series data indicative of millions of transactional activities;
means for determining at least one statistical characteristic of the time series data;
means for comparing the determined statistical characteristic of the time series data with the pre-identified model characteristic of the forecasting models in the pool to identify candidate forecasting models;
means for determining a data subset from the time series data and a hold-out sample from the time series data;
means for optimizing for each time series at least one parameter of the candidate forecasting models using the time series data subset;
means for calculating statistics-of-fit for the candidate forecasting models using the hold-out sample; and
means for selecting at least one of the candidate forecasting models based upon the calculated statistics-of-fit of the candidate forecasting models.
